(19) United States
(12) Patent Application Publication
(10) Pub. No.: US 2003/0197371 A1
(43) Pub. Date: Oct. 23, 2003

(54) Flexible piping connector

(75) Inventor: James Kenneth McAlpine, Glasgow (GB)

Correspondence Address: DYKAS, SHAVER & NIPPER, LLP, P O BOX 877, BOISE, ID, 83701-0877, US

(73) Assignee: McAlpine & Company Limited, Glasgow (GB)

(21) Appl. No.: 10/131,779

(22) Filed: Apr. 22, 2002

(51) Int. Cl. F16L 21/00

(52) U.S. Cl. 285/237

(57) ABSTRACT

A flexible piping connector 10 includes a flexible elastomeric tubular member 12, with a central annular groove formed around the circumference of the member. Two rigid plastics tubular members 20, 22 engage with the flexible tubular member 12, while inner annular members 28 retain the flexible tubular member 12 in co-operation with the rigid members 20, 22. The rigid members 20, 22 may be connected to sections of piping, while the flexible member 12 allows the assembly to be flexed through a restricted range of angles to allow for construction of piping lengths at non-standard angles, while the connector retains a smooth inner bore.

### FIELD OF THE INVENTION

The present invention relates to a flexible piping connector; in particular a connector for use in connecting lengths of piping for use in plumbing.

### BACKGROUND OF THE INVENTION

There are various situations encountered during plumbing works in which it is desirable to make use of a length of piping which is not straight. For example, when fitting bath overflow piping, the overflow pipe is normally led from the bath overflow outlet to join with the bath waste outlet. Due to the shape of a typical bathtub, in particular the curvature or inclination of the bath wall, it is necessary for the overflow piping to have some degree of curvature or be provided with angled couplings to reach and connect into the waste outlet piping. While rigid piping can be used for this purpose, the lack of standardisation of bathtubs means that it is necessary to provide a range of sizes and angles of rigid piping.

An alternative is to make use of flexible piping. One particular form of flexible piping consists of a length of pleated plastics piping, with the pleats being constructed so as to remain in an expanded or contracted position when so placed; thus a curve may be introduced into the piping, and allow the piping to be led around the wall of a bathtub to join the waste outlet. Such piping is described in, for example, UK Patent Application GB2298470, to Dalatek Limited, and in U.S. Pat. No. 4,927,191, to Twentieth Century Companies, Inc.

One perceived problem with this form of flexible piping is the presence of internal corrugations in the pipe bore, due to the pleats. Such piping therefore may not be given regulatory approval for the highest classification of plumbing products, as the internal corrugations are believed by some to increase the risk of both material flowing along the piping becoming snagged or trapped in the corrugations, and of waste water gathering or being retained in the corrugations. The piping thus may not be considered as hygienic as smooth bore piping, with plumbers and local authorities then being reluctant to use the lower classification piping.

It is among the objects of embodiments of the present invention to obviate or alleviate these and other disadvantages of known flexible piping. It is further among the objects of embodiments of the present invention to provide a flexible piping connector which may be used in situations where a low degree of curvature is required.

### SUMMARY OF THE INVENTION

According to a first aspect of the invention, there is provided a flexible piping connector comprising a tubular flexible member and at least two flanking rigid tubular members located concentric with and axially displaced either side of the flexible member, wherein at least one of the rigid members comprises means for connecting with a section of piping, and wherein the connector has a substantially smooth inner bore surface.

Thus, the present invention provides a section of flexible material between two rigid sections which connect to piping sections, thereby allowing a degree of relative movement of the piping sections thereby connected. While it is recognised that the connector will generally not be able to flex through as much as 90 □ without buckling, in the context of bathtub waste connections and similar plumbing works, it is typically only necessary to provide a curvature of a maximum of 15 □; connectors according to preferred embodiments of the present invention are capable of providing such curvature without buckling. In one embodiment, the connectors may be adapted to prevent curvature above a selected angle; for example, a connector may only permit curvature between 0 and 15□. Conveniently this may be achieved by, for example, location of the rigid members such that the rigid members will interfere with one another above the selected angle, such that curvature beyond this is difficult or not possible.

“Substantially smooth” in the context of the present invention implies that the inner bore surface of the connector does not have any corrugations or ridges that may impede flow of liquids and other materials along the bore. The bore surface need not be entirely flat, and some changes of inner diameter of the bore are acceptable, provided they are gradual and not repeated.

Preferably the flexible member is made from an elastomeric material; conveniently rubber. Alternatively, the flexible member may be made from a more rigid material, such as plastics, if a weaker section of the material, for example a thinner-walled region, is provided to allow flexion of the member.

The flexible member may provide the smooth inner bore surface alone, with the rigid members not forming a part of the inner bore surface; it is preferred however that the flexible and rigid members in combination define a smooth inner bore surface.

Preferably the flexible member comprises a predefined flexion location, where the member will preferentially flex. This serves to reduce the risk of buckling or of other undesired bending of the member. The predefined flexion location may take the form of a thinning or other weakening in the material making up the flexible member. Alternatively the flexion location may comprise an annular ridge or depression around a circumferential section of the member. Preferably an external depression is formed on the flexible member.

Preferably the flexible and rigid members are constructed such that at least a portion of one of the flexible or rigid members fits inside at least a portion of the other of the flexible or rigid members. Preferably this is achieved by providing a portion on each of the flexible and rigid members, the portion on one of the flexible or rigid member having a differing diameter from the corresponding portion on the other of the flexible or rigid member. Preferably portions of the flexible member fit inside a portion of each of the rigid members. The flexible member thus has two such portions, while each of the rigid members has one such portion.

Where the flexible member fits inside the rigid members, the connector may further comprise one or more inner rigid annuli located inside the flexible member; these serve to stiffen and smooth the inner bore wall, as well as acting to retain the flexible member in contact with the rigid members. The rigid annuli are preferably distinct from the rigid members; alternatively the rigid annuli may be integral with the rigid members, to form a recessed annular socket portion within which the flexible member may sit.

Preferably the rigid members are made from plastics material, although metal or ceramic may be used if desired.

According to a second aspect of the present invention, there is provided a tubular flexible member for use in a flexible piping connector, the flexible member having means for engaging with rigid tubular members and for defining a substantially smooth inner bore wall when engaged with said tubular members.

The flexible member may further comprise a predetermined flexion location.

According to a further aspect of the present invention, there is provided a piping section comprising a tubular flexible member and at least two flanking rigid tubular piping members located concentric with and axially displaced either side of the flexible member, wherein the piping section has a substantially smooth inner bore surface.

### BRIEF DESCRIPTION OF THE DRAWINGS

These and other aspects of the present invention will now be described by way of example only and with reference to the accompanying drawings, in which:

FIG. 1 shows a flexible piping connector in accordance with a first embodiment of the present invention;

FIGS. 2 and 3 show rigid tubular members of the connector of FIG. 1;

FIG. 4 shows a flexible tubular member of the connector of FIG. 1;

FIG. 5 shows an annular retaining member of the connector of FIG. 1; and

FIGS. 6 and 7 show an alternative connector and rigid member respectively.

### DETAILED DESCRIPTION OF THE DRAWINGS

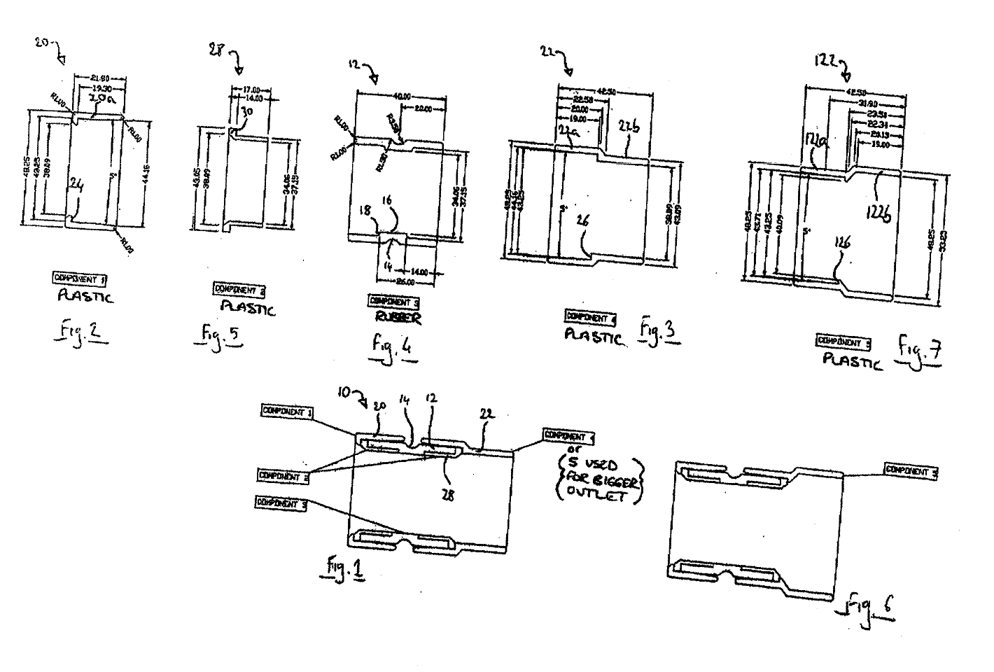

Referring first of all to FIG. 1, this shows a flexible connector 10 in accordance with an embodiment of the present invention. The connector 10 comprises a flexible elastomeric tubular member 12, shown separately in FIG. 4. The flexible member 12 has a central annular groove 14 formed around the circumference of the member 12, with a corresponding protrusion 16 formed inside the member 12. The protrusion 16 provides a pair of shoulders 18 against which other components of the connector 10 may abut, as described below.

Flanking the flexible member 12 on either side are two differing rigid plastics tubular members 20, 22, shown individually in FIGS. 2 and 3 respectively. Both rigid members 20, 22 have a major portion 20a, 22a of sufficient diameter to receive the flexible member 12 therein; the rigid member 22 also has a minor portion 22b of reduced diameter (in fact, the same diameter as the end portions of the flexible member 12) extending away from the flexible member 12. The minor portion 22b in use will fit within a section of piping to form a connection thereto. The rigid members 20, 22 are further provided with shoulders 24, 26 formed at the end of the major portion 20a, 22a respectively.

An alternative rigid member 122 is illustrated in FIG. 7, and assembled with the remainder of the connector 110 in FIG. 6. This has an identical major portion 122a to the rigid member 22, and similar shoulders 126, although the minor portion 122b is of enlarged diameter. This allows the connector to be fitted to larger diameter piping. It will be understood that numerous other variant rigid portions may be used; and also that both rigid portions may be identical if desired.

The connector 10 is also provided with two annular members 28 (FIG. 5) located internally of the flexible member 12. These are designed and sized to fit within the ends of the flexible member, and to abut the shoulders 18 provided on the protrusion 16 of the flexible member 12. Corresponding flanges 30 at one end of the annular member 28 fit over the ends of the flexible member 12, to provide a secure fit. The annular members 28 complement the flexible member 12 to provide a bore through the connector 10 of substantially constant diameter. The internal surfaces of the bore are of course produced so as to be substantially smooth.

To assemble the connector 10, once the annular members 28 are located on the flexible member 12, the rigid members 20, 22 are seated over the flexible member 12. The flanges 30 of the annular members 28 abut the shoulders 24, 26 of the rigid members 20, 22 to hold all the components in place. The annular members 28 are constructed so as to be in slight compression when the connector is assembled, so as to press the flexible member 12 against the rigid members 20, 22 and reduce the risk of the flexible member 12 coming away from the rigid members 20, 22.

The connector 10 may then be used to connect to piping sections of a suitable diameter. Additional adapter components may of course be used if necessary. The flexible member 12 may be bent through up to 15 □ without buckling, by virtue of the groove 14 formed therein, while the rigid members 20, 22 restrict the bending radius of the connector 10 to reduce possible buckling.

The connector 10 may therefore be used to connect piping sections together which are to be held at an angle to one another. The internal bore of the connector 10 is kept substantially smooth, which reduces the risks of disrupting flow of fluids therein.

The above-described embodiments are for information only, and the skilled person will conceive of numerous modifications and variants which are encompassed within the scope of the present invention.

I claim:

1. A flexible piping connector comprising a tubular flexible member and at least two flanking rigid tubular members located concentric with and axially displaced either side of the flexible member, wherein at least one of the rigid members comprises means for connecting with a section of piping, and wherein the connector has a substantially smooth inner bore surface.

2. Flexible piping connector according to claim 1, wherein the connector is adapted to prevent curvature above a selected angle.

3. Flexible piping connector according to claim 2, wherein the connector only permits curvature between 0 and 15□.

4. Flexible piping connector according to claim 2, wherein the rigid members are located such that the rigid members will interfere with one another above the selected angle.

5. Flexible piping connector according to claim 1, wherein the flexible member is made from an elastomeric material.

6. Flexible piping connector according to claim 1, wherein the flexible member includes a weaker section of material to allow flexion of the member.

7. Flexible piping connector according to claim 1, wherein the flexible member provides the smooth inner bore surface alone.

8. Flexible piping connector according to claim 1, wherein the flexible and rigid members in combination define a smooth inner bore surface.

9. Flexible piping connector according to claim 1, wherein the flexible member comprises a predefined flexion location, where the member will preferentially flex.

10. Flexible piping connector according to claim 9, wherein the predefined flexion location takes the form of a weakening in material making up the flexible member.

11. Flexible piping connector according to claim 9, wherein the flexion location comprises one of an annular ridge and an annular depression around a circumferential section of the member.

12. Flexible piping connector according to claim 11, wherein an external depression is formed on the flexible member.

13. Flexible piping connector according to claim 1, wherein at least a portion of one of the flexible or rigid members fits inside at least a portion of the other of the flexible or rigid members.

14. Flexible piping connector according to claim 13, wherein portions of the flexible member fit inside a portion of each of the rigid members.

15. Flexible piping connector according to claim 14, wherein the connector further comprises at least one inner rigid annulus located inside the flexible member.

16. Flexible piping connector according to claim 1, wherein the rigid members are made from plastics material.

17. A tubular flexible member for use in a flexible piping connector, the flexible member having means for engaging with rigid tubular members and for defining a substantially smooth inner bore wall when engaged with said tubular members.

18. The flexible member of claim 17, further comprising a predetermined flexion location.

19. A piping section comprising a tubular flexible member and at least two flanking rigid tubular piping members located concentric with and axially displaced either side of the flexible member, wherein the piping section has a substantially smooth inner bore surface.
